(19) United States
(12) Patent Application Publication
(10) Pub. No.: US 2005/0009940 A1
(43) Pub. Date: Jan. 13, 2005

(54) Method of promoting the sale of a melamine foam piece and an article of manufacture

(75) Inventors: Alan Scott Goldstein, Cincinnati, OH (US); Jorge Mesquita, Cincinnati, OH (US); Guy B. Persaud, Cincinnati, OH (US); Karl Patrick Ronn, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/882,502

(22) Filed: Jul. 1, 2004

Related U.S. Application Data
(60) Provisional application No. 60/485,857, filed on Jul. 9, 2003.

(51) Int. Cl. C08K 3/00

(52) U.S. Cl. 521/128

(57) ABSTRACT

The present invention relates to a method of promoting the sale of a melamine foam piece and an article of manufacture comprising a melamine foam piece.

### CROSS REFERENCE TO RELATED APPLICATIONS

This application claims the benefit of the filing date of U.S. Provisional Application No. 60/458,857 filed Jul. 9, 2003, the disclosure of which is incorporated by reference herein.

### TECHNICAL FIELD

The present invention relates to a method of promoting the sale of a melamine foam piece and an article of manufacture comprising a melamine foam piece.

### BACKGROUND OF THE INVENTION

Melamine-formaldehyde resin foams, also referred to herein as melamine foams, are well known in the art for use in industrial applications, for example, as heat or sound insulating materials as well as for fire protection purposes. Indeed, in the automotive industry, melamine foam is commonly used to insulate motor compartments and driver cabins of cars and trucks.

In the very recent past, a novel application for such melamine foams in the area of hard surface cleaning has been discovered. Indeed, in several Asian countries and territories, especially in Japan, cut or molded pieces of melamine foam have become popular to remove soils and/or stains from hard surfaces such as tiles, walls, floors, sanitary fittings such as sinks, showers, shower curtains, wash basins, WCs, household appliances including, but not limited to, refrigerators, freezers, washing machines, automatic dryers, ovens, microwave ovens, dishwashers and so on.

Surprisingly it is has been discovered that melamine foam shows an excellent soil and/or stain removal performance when used to clean hard surfaces. Indeed, it has been observed that melamine foam when wetted with an appropriate solvent, such as tap water, removes soils and/or stains from a hard surface when said hard surface is brought into contacted with said wetted melamine foam. Surprisingly it has been found that the removal of stains and/or soils does not require the use of a detergent composition, indeed stain and/or soil removal is exhibited when the melamine foam is wetted with plain water. By “bringing into contact” it is meant wiping, swiping, rubbing or the like. The melamine foam comes off in a particulate form (meaning, the foam crumbles) when brought into contact with a hard surface. In this respect the melamine foam acts in a way similar to a pencil eraser.

As stated above, the application of melamine foam in the domestic US has been limited so far to industrial applications and their use in hard surface cleaning was mostly limited to Japan and other Asian countries. Hence, domestic consumers are unaware of the fact that melamine foams can be used to remove stains and/or soils from hard surfaces, let alone are these consumers aware of the very beneficial properties with regard to soil and/or stain removal of said melamine foams. Furthermore, it has been discovered by consumer research that consumers are not able to immediately associate melamine foams with any existing means to remove stains and/or soils from hard surfaces, such as hard surface cleaners, moist hard surface cleaning wipes, etc. Indeed, melamine foams are recognized by consumers as a completely new way and/or new means for cleaning hard surfaces.

It has also been found that consumers are in general reluctant to try and/or use new cleaning means for cleaning hard surfaces. This is especially true if a new cleaning means, such as the melamine foams herein, significantly differs from the currently known cleaning means, such as moist hard surface cleaning wipes, colored polyurethane sponges (for example, available under the trade name Scotch-Brite®), liquid hard surface cleaners, solid or liquid scouring compositions, and the like. Furthermore, as mentioned above melamine foam exhibits soil and/or stain removal performance even without the use of a detergent composition, such as a hard surface cleaner composition. This may lead to further reluctance in the consumer's mind in the particular case of the melamine foam pieces' use to clean hard surfaces. In conclusion, there is a general prejudice in the consumer's mind against employing a new cleaning means for cleaning hard surfaces and in particular to using melamine foam pieces for cleaning hard surfaces.

It is therefore, an objective of the present invention to overcome the above mentioned prejudice by educating consumers of the new use of melamine foam in hard surface cleaning, especially to remove stains and/or soils from hard surfaces.

It has now been found that the above objective can be met by associating a piece of melamine foam with the brand name and/or logo of a hard surface cleaner. Alternatively it has also been found that this objective can be met by associating a piece of melamine foam with a term or a multitude thereof that refers to melamine foam's eraser-like properties. Furthermore, combinations of the above may also be employed to meet the above objective.

### SUMMARY OF THE INVENTION

The present invention encompasses a method of promoting the sale of a melamine foam piece by associating said piece with the brand name and/or logo of a hard surface cleaner.

The present invention further encompasses an article of manufacture comprising a melamine foam piece and a packaging means for said melamine foam piece, wherein said packaging means features the brand-name and/or logo of a hard surface cleaner composition.

The present invention further encompasses an article of manufacture comprising a melamine foam piece wherein said melamine foam piece features the brand name and/or logo of a hard surface cleaner composition.

The present invention further encompasses a method of promoting the sale of a melamine foam piece by associating said piece with a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

The present invention further encompasses an article of manufacture comprising a melamine foam piece and a packaging means for said melamine foam piece, wherein said packaging means features an indication comprising a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

The present invention further encompasses an article of manufacture comprising a melamine foam piece and a packaging means for said melamine foam piece, wherein said melamine foam piece features an indication comprising a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

### BRIEF DESCRIPTION OF THE DRAWINGS

FIG. 1 is a perspective view of a melamine foam piece featuring the Mr. Clean® Head logo.

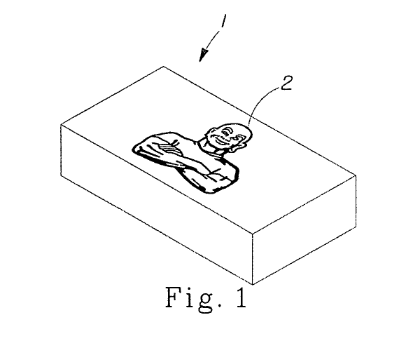

### DESCRIPTION OF THE REFERENCE NUMERALS

1: Melamine foam piece
2: Mr. Clean® Head logo

### DETAILED DESCRIPTION OF THE INVENTION

Method of Promoting the Sale of a Melamine Foam Piece and Article of Manufacture

The present invention encompasses a method of promoting the sale of a melamine foam piece by associating said piece with the brand name and/or logo of a hard surface cleaner.

The present invention further encompasses an article of manufacture comprising a melamine foam piece and a packaging means for said melamine foam piece, wherein said packaging means features the brand-name and/or logo of a hard surface cleaner composition.

The present invention further encompasses an article of manufacture comprising a melamine foam piece wherein said melamine foam piece features the brand name and/or logo of a hard surface cleaner composition.

The present invention further encompasses a method of promoting the sale of a melamine foam piece by associating said piece with a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

The present invention further encompasses an article of manufacture comprising a melamine foam piece and a packaging means for said melamine foam piece, wherein said packaging means features an indication comprising a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

The present invention further encompasses an article of manufacture comprising a melamine foam piece and a packaging means for said melamine foam piece, wherein said melamine foam piece features an indication comprising a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

By “associating” it is meant herein creating a link in a consumer's mind between the melamine foam piece and a specific term, a brand name or logo, such as the brand-name and/or logo of a hard surface cleaner, to be linked to said piece.

By “brand-name of a hard surface cleaner” it is meant herein the name under which a hard surface cleaner is or was marketed to consumers, preferably on the domestic market. Preferably, under a hard surface cleaner it is understood herein, moist hard surface cleaning wipes, liquid hard surface cleaners, solid or liquid scouring compositions, and the like. In a preferred embodiment herein, said brand name of a hard surface cleaner is the brand name of a hard surface cleaner recognized by consumers. Examples of brand names of hard surface cleaner are selected from the group consisting of: Mr. Clean®, Mr. Proper®, Flash®, AJAX®, Fabuloso®, Cif®, Clorox®, Pine-Sol®, and Lysol®, Scrubbing Bubbles®, Fantastic®, 409®, Tilex®, Scrubby®, Comet® and combinations thereof.

By “logo of a hard surface cleaner” it is meant herein the logo of a hard surface cleaner as described above. In a preferred embodiment herein, said logo of a hard surface cleaner is the logo of a hard surface cleaner recognized by consumers. Examples of logos of a hard surface cleaner are selected from the group consisting of: Mr. Clean® Head.

The term or a multitude thereof herein that refers to melamine foam's eraser-like properties (herein below referred to as “specific terms”) may be selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof. Preferably, said term that refers to melamine foam's eraser-like properties is: eraser.

The association of the brand-name and/or logo of a hard surface cleaner or the specific terms as indicated herein above with said piece of melamine foam may be performed in any suitable way, preferably in a way for a consumer to understand a link between said brand-name and/or logo of a hard surface cleaner or said specific terms as indicated herein above with said piece of melamine foam.

Indeed, said brand-name and/or logo of a hard surface cleaner or said specific terms as indicated herein above may be featured directly on the said melamine foam piece, by for example, printing or embossing said melamine foam piece with said brand-name and/or logo of a hard surface cleaner or said specific terms as indicated herein. Alternatively, said brand-name and/or logo of a hard surface cleaner or said specific terms as indicated herein may be featured (e.g., printed) on the packaging means, if any, of said melamine foam piece. Furthermore, said brand-name and/or logo of a hard surface cleaner or said specific terms as indicated herein above may be associated to said melamine foam piece and/or to it the packaging means, if any, of said melamine foam piece by means of a label applied thereto. Said label may be glued or by any other means known to those skilled in the art affixed or attached to said melamine foam piece and/or to the packaging means, if any, of said melamine foam piece. Moreover, said brand-name and/or logo of a hard surface cleaner or said specific terms as indicated herein above may be presented with said melamine foam piece and/or with the packaging means, if any, of said melamine foam piece in a separate manner, including but not limited to, a brochure, print advertisement, electronic advertisement, point-of-sale information, in-store displays and/or verbal communication.

Furthermore, any combinations of the above described ways of associating said brand-name and/or logo of a hard surface cleaner or said specific terms as indicated herein above with a melamine foam piece may be used.

Indeed, in a highly preferred embodiment herein, the melamine foam piece as well as the packaging means, if any, for said piece independently feature the brand name of a hard surface cleaner and/or the logo of a hard surface cleaner and/or said specific terms as indicated herein above.

As a highly preferred embodiment the present invention encompasses a method of promoting the sale of a melamine foam piece by associating said piece with the Mr. Clean® brand-name and/or the Mr. Clean® Head logo.

As another highly preferred embodiment the present invention encompasses an article of manufacture comprising a melamine foam piece and a packaging means for said melamine foam piece, wherein said packaging means features the Mr. Clean® brand-name and/or the Mr. Clean® Head logo.

As another highly preferred embodiment the present invention encompasses an article of manufacture comprising a melamine foam piece wherein said melamine foam piece features the Mr. Clean® brand name and/or the Mr. Clean® Head logo.

As another highly preferred embodiment the present invention encompasses a method of promoting the sale of a melamine foam piece by associating said piece with the term: eraser.

As another highly preferred embodiment the present invention encompasses a melamine foam piece and a packaging means for said melamine foam piece, wherein said packaging means features an indication comprising the term: eraser.

As another highly preferred embodiment the present invention encompasses a melamine foam piece and a packaging means for said melamine foam piece, wherein said melamine foam piece features an indication comprising the term: eraser.

Melamine Foam

By “melamine foam” it is meant herein a melamine-formaldehyde resin foam.

A suitable melamine-formaldehyde resin foam raw material is commercially available under the trade name Basotect® from BASF.

The “melamine foam” described above can be prepared by blending major starting materials of melamine and formaldehyde, or a precursor thereof, with a blowing agent, a catalyst and an emulsifier, injecting the resultant mixture into a mold, and making the reaction mixture generate heat through a proper means such as heating or irradiation with electromagnetic wave to cause foaming and curing. The molar ratio of melamine to formaldehyde (i.e., melamine:formaldehyde) for producing the precursor is preferably 1:1.5 to 1:4, particularly preferably 1:2 to 1:3.5 in melamine:formaldehyde. In addition, number average molecular weight of the precursor is preferably 200 to 1,000, particularly preferably 200 to 400. Additionally, formalin, which is an aqueous solution of formaldehyde, is usually used as formaldehyde.

As monomers for producing the precursor, the following various monomers may be used in an amount of 50 parts by weight (hereinafter abbreviated as “parts”) or less, particularly 20 parts by weight or less, per 100 parts by weight of the sum of melamine and formaldehyde in addition to melamine and formaldehyde. As other monomers corresponding to melamine, there may be used C1-5 alkyl-substituted melamines such as methylolmelamine, methylmethylolmelamine and methylbutylolmelamine, urea, urethane, carbonic acid amides, dicyandiamide, guanidine, sulfurylamides, sulfonic acid amides, aliphatic amines, phenols and the derivatives thereof. As aldehydes, there may be used acetaldehyde, trimethylol acetaldehyde, acrolein, benzaldehyde, furfurol, glyoxal, phthalaldehyde, terephthalaldehyde, etc.

As the blowing agent, there may be used pentane, trichlorofluoromethane, trichlorotrifluoroethane, etc. However, use of so-called fleons® such as trichlorofluoromethane is regulated from the point of view of environmental problems, thus not being preferred. On the other hand, pentane is preferred in that it easily provides a foam when used even in a small amount but, since it has a volatile flammability, it requires sufficient care in its handling. Further, as the catalyst, formic acid is commonly used and, as the emulsifier, anionic surfactants such as sodium sulfonate may be used.

The amount of the electromagnetic wave to be irradiated for accelerating the curing reaction of the reaction mixtures is preferably adjusted to be 500 to 1,000 kW, particularly 600 to 800 kW, in electric power consumption based on 1 kg of an aqueous formaldehyde solution charged in the mold. In case when this electric power consumption is insufficient, there results an insufficient foaming, leading to production of a cured product with a high density. On the other hand, in case when the electric power consumption is excessive, the pressure upon foaming becomes seriously high, leading to serious exhaustion of the mold and even the possibility of explosion. Thus, electric power consumption outside the range is not preferred.

By a “piece” of melamine foam, it is meant herein a portion of melamine foam. This piece can be virtually of any shape and/or size and/or volume.

In a preferred embodiment according to the present invention, the piece of melamine foam is in a shape and/or size and/or volume suitable for use by a consumer to clean hard surfaces therewith.

Suitable shapes of pieces of melamine foam may be selected from the group consisting of cube shape, rectangular shape, pyramid shape, cylindrical shape, cone shape, pencil eraser shape, cuboid shape, and tetrahedron shape.

Suitable volumes of pieces of melamine foam may be from about 1 cm³ to about 10.000 cm³, preferably from about 10 cm³ to about 1.000 cm³, more preferably from about 50 cm³ to about 200 cm³.

In a highly preferred embodiment herein, the melamine foam piece has a cuboid shape defined by three groups of parallel and equal length sides, referred to as a, b and c, wherein a ranges from about 1 cm to about 20 cm, preferably about 4 cm to about 8 cm, b ranges from about 1 cm to about 20 cm preferably about 8 cm to about 15 cm, and c ranges from about 1 cm to about 5 cm, preferably about 1 cm to about 3 cm.

In another highly preferred embodiment herein is in the shape of a pencil eraser. By “shape of a pencil eraser” it is meant herein a voluminous body having six walls, wherein three pairs of parallel and equally shaped and sized walls exist and wherein one pair of walls are in the shape of a parallelogram and the remaining two pairs of walls are of rectangular shape.

In order to obtain melamine foam pieces, the melamine foam raw material may have to be modified in shape and/or size. This modification can be done by any means known to those skilled in the art. Suitable means of modifying the shape and/or size of melamine foam raw material may be selected from the group consisting of: compression, heat-compression, cutting, breaking, and tearing, and combinations thereof.

The melamine foam piece herein may be modified or post-processed. In particular, such modification and/or post-processing of the melamine foam piece may be used to associate said brand-name and/or logo of a hard surface cleaner or said specific terms as indicated herein above with said melamine foam piece. Suitable modification and/or post-processing of the melamine foam piece may be printing on said melamine foam piece, and embossing of said melamine foam piece using heat and/or pressure, and combinations thereof.

Packaging Means

The melamine foam piece may be combined in an article of manufacture with a packaging means.

The packaging means herein may be any suitable means known to package melamine foam pieces. Indeed, particularly suitable packaging means herein are selected from the group consisting of: paper bags, plastic bags, cartons, carton boxes, flow wraps, plastic wraps, and paper wraps, and the like and combinations thereof.

The packaging means herein may be printed and/or modified. In particular, such printing and/or other modification may be used to associate said brand-name and/or logo of a hard surface cleaner or said specific terms as indicated herein above with said melamine foam piece.

1. A method of promoting the sale of a melamine foam piece by associating said piece with the brand name and/or logo of a hard surface cleaner.

2. A method according to claim 1, wherein said brand-name and/or logo of a hard surface cleaner is featured on the melamine foam piece and/or on the packaging means of said melamine foam means.

3. A method according to claim 1, wherein said brand-name and/or logo of a hard surface cleaner is featured together with said melamine foam piece and/or with the packaging means of said melamine foam piece in a way chosen from: a brochure, a print advertisement, an electronic advertisement, point-of-sale information, an in-store display, in a verbal communication and combinations thereof.

4. A method according to claim 1, wherein said melamine foam piece is further associated with a term chosen from: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

5. An article of manufacture comprising a melamine foam piece and a packaging means for said melamine foam piece, wherein said packaging means features the brand-name and/or logo of a hard surface cleaner composition.

6. An article of manufacture according to claim 5, wherein said packaging means is further associated with a term chosen from: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

7. An article of manufacture according to claim 6, wherein said packaging means is further associated with the term: eraser.

8. An article of manufacture comprising a melamine foam piece wherein said melamine foam piece features the brand name and/or logo of a hard surface cleaner composition.

9. An article of manufacture according to claim 8, wherein said melamine foam piece is further associated with a term selected from the group consisting of: eraser, erazer, erasor, erazor, eraso, erasa, erazo, erazo, erasser, erassor, erasso, erassa, erazzer, erazzor, erazzo, erazza, remover, remova, removor, removo, removar and the like, and combinations thereof.

10. An article of manufacture according to claim 9, wherein said packaging means is associated with the term: eraser.
